(19) United States
(12) Patent Application Publication
(10) Pub. No.: US 2023/0259764 A1
(43) Pub. Date: Aug. 17, 2023

(54) Automated Monitoring of Artificial Intelligence

(71) Applicant: Siemens Aktiengesellschaft, München (DE)

(72) Inventor: Kai Höfig, Rohrdorf (DE)

(73) Assignee: Siemens Aktiengesellschaft, München (DE)

(21) Appl. No.: 18/003,786

(22) PCT Filed: Jun. 21, 2021
(86) PCT No.: PCT/EP2021/066796

§ 371 Date: Dec. 29, 2022

(30) Foreign Application Priority Data
Jul. 1, 2020 (EP) 20183413.2

(51) Int. Cl. G06N 3/08

(52) U.S. Cl. CPC G06N 3/08

(57) ABSTRACT

Various embodiments of the teachings herein include an automated method for generating a monitor model of a monitor having a first neural network for monitoring a working model of an artificial intelligence having a second neural network. In some embodiments, the method includes: classifying input data using the working model; and training the monitoring model using a representative volume of data of the working model. The representative volume of data is used as the input for the first neural network. The representative volume of data is formed by the output of the activation functions of the neurons of the second neural network.

### CROSS-REFERENCE TO RELATED APPLICATIONS

This application is a U.S. National Stage Application of International Application No. PCT/EP2021/066796 filed Jun. 21, 2021, which designates the United States of America, and claims priority to EP Application No. 20183413.2 filed Jul. 1, 2020, the contents of which are hereby incorporated by reference in their entirety.

### TECHNICAL FIELD

The present disclosure relates to artificial intelligence (AI). Various embodiments of the teachings herein include automated methods and/or devices for generating a monitoring model of a monitor for monitoring a working model of an artificial intelligence.

### BACKGROUND

Neural networks are a popular technology from the domain of artificial intelligence for efficiently processing image data, in particular, and for recognizing specific objects in the runtime of a system by means of training data. There is an increasing desire to use this technology in safety-critical systems also. In contrast to conventional, rule-based algorithms, the output of a neural network does not correspond to a conventional and precisely formulated requirement which has been implemented in software by a developer, but has been learnt by a computer by means of test data provided in design time.

In the same way that, in the case of conventional algorithms, the solution of a program is intended to correspond to the requirements, in the case of a neural network or generally in the case of artificial intelligence algorithms, the result is intended to correspond to the training data. Strictly speaking, the training data correspond to the conventional requirements. A popular technology for checking the limits of complex algorithms in runtime and for ensuring that the parameters correspond in runtime to the operating parameters defined in the requirements is the monitor.

A monitor is a technical element, frequently an embedded system, which checks specific runtime parameters of a complex system in runtime on the basis of very simple rule-based algorithms. One example of this is an embedded system which checks whether a different system is still active, or has already crashed. A monitor which operates in a similar manner for neural networks or artificial intelligence algorithms in general therefore monitors compliance with the training data.

A conventional monitor technology has hitherto been proposed for use in neural networks or other artificial intelligence algorithms also. As with conventional algorithms, the runtime parameters can also be checked for compliance with specific limits which have been calculated by an AI algorithm. However, this procedure is not particularly helpful, since an incorrectly recognized road sign and the corresponding response of a system can hardly be distinguished by an approach of this type from the response to a correctly recognized road sign.

Attempts have therefore hitherto been made to pay particular attention to high-quality training data. Other approaches focus on the formal verification of AI-based algorithms and still other approaches attempt to detect manipulations (adversarial attacks) on image data in runtime.

The development of a monitor which checks whether the decision of a neural network is based on the training data can furthermore be found in Runtime Monitoring Neuron Activation Patterns by Chih-Hong Cheng, Georg Nührenberg, Hirotoshi Yasuoka (https://arxiv.org/abs/1809.06573). In this technology, however, activation patterns are collected from a neural network in the newly performed analysis of the training data and deviations are then recorded in runtime by way of the Hamming distance of the patterns occurring in runtime. If an excessive deviation occurs, the monitor reports a detected error to the system.

The problem with this technology is, above all, poor scalability. The authors indicate the current technical feasibility for a Hamming-distance-based method of this type with binary decision trees of 200 neurons. In the domain of deep learning, where above all image data are processed, the number of neurons is quickly exceeded. AlexNet, for example, has around 650,000 neurons. In addition, slight deviations between detected patterns and the stored patterns are permitted, but adjustment again represents a manual task.

### SUMMARY

The teachings of the present disclosure include solutions for improved monitoring of artificial intelligence algorithms, such as, for example, working models of artificial neural networks. For example, some embodiments include an automated method for generating a monitor model of a monitor having a first neural network (1) for monitoring a working model of an artificial intelligence having a second neural network (2), wherein a classification of input data is carried out by means of the working model, and wherein the monitoring model is trained using a representative volume of data of the working model, wherein the representative volume of data is used as the input for the first neural network (1), and wherein the representative volume of data is formed by the output (3) of the activation functions of the neurons of the second neural network (2).

In some embodiments, the monitor model is trained by inputting the training data (4.1) into the working model which is fully trained with training data (4.1), and by running said training data (4.1) through the working model once more for analysis, wherein the monitor model learns a set of valid activation patterns and/or activation paths which the working model can achieve.

As another example, some embodiments include a device, having an artificial intelligence and a monitor for monitoring a working model of the artificial intelligence, wherein the artificial intelligence is configured to perform a classification of input data by means of the working model, wherein a monitor model of the monitor is trained with a representative volume of data of the working model, wherein the monitor has an artificial first neural network (1) and the input for the first neural network (1) is formed by the representative volume of data, and wherein the artificial intelligence has an artificial second neural network (2), wherein the representative volume of data is formed by the output (3) of the activation functions of the neurons of the second neural network (2).

In some embodiments, the device is configured to train the monitor model by inputting the training data (4.1) or a part of the training data (4.1) into the working model which is fully trained with training data (4.1) and by running said training data (4.1) through the working model once more for analysis, wherein the monitor model learns a set of valid activation patterns and/or activation paths which the working model can achieve.

As another example, some embodiments include a computer program product, comprising a computer program, wherein the computer program is loadable into a storage device of a device, wherein the steps of one or more of the methods as described herein are carried out with the computer program when the computer program is executed on the device.

As another example, some embodiments include a computer-readable medium on which a computer program is stored, wherein the computer program is loadable into a storage device of a device, wherein the steps of one or more of the methods as described herein are carried out with the computer program when the computer program is executed on the device.

### BRIEF DESCRIPTION OF THE DRAWINGS

Further characteristics and advantages of the teachings herein are set out in the following explanations of an exemplary embodiment with reference to two schematic drawings. In the drawing:

FIG. 1 shows a block diagram of an exemplary embodiment with neural networks; and

FIG. 2 shows a flow diagram of an automated method for generating a monitor model of a monitor for monitoring a working model of an artificial intelligence.

### DETAILED DESCRIPTION

The teachings of the present disclosure may be used to generate a monitor for artificial neural networks or other artificial intelligence algorithms fully automatically. With a technique of this type, unlike the aforementioned methods, the set of valid activation patterns or activation paths is no longer conventionally stored and manually adjusted, but is instead learnt in an automated manner.

A first neural network generates an output from a set of input values by means of a model, this being referred to as a working model. In addition, a second neural network is configured, i.e. the monitor model, which receives as input values the output of the activation functions of all neurons of the working model of the first neural network. In some embodiments, any other representative volume of data of an AI-based algorithm which represents the classification of a given dataset can also be chosen.

In order to train the monitor model, the working model, following the completion of its training runs through its training once more for analysis. During this run, the monitor model is trained and in this way learns all “good patterns” which the working model can achieve. Tolerances for slight deviations are produced automatically with this method, since the trained second neural network also learns the variance of the activation patterns.

In some embodiments, there is an automated or computer-implemented method for generating a monitor model of a monitor for monitoring a working model of an artificial intelligence, wherein a classification of input data is carried out by means of the working model, and wherein the monitoring model is trained using a representative volume of data of the working model. The monitor model can be regarded as the “super-ego” or as the “conscience” of the working model. The invention offers the advantage that errors can be detected during the operation of the artificial intelligence.

The monitor has an artificial first neural network and the representative volume of data is used as input for the first neural network. The artificial intelligence has an artificial second neural network, wherein the representative volume of data is formed by the output of the activation functions of the neurons of the second neural network.

In some embodiments, the model can be trained by inputting the training data once more for analysis into the working model which is fully trained with training data, and by running said training data through the working model once more, wherein the monitor model learns a set of valid activation patterns and/or activation paths which the working model can achieve. The monitor model thus learns all “good patterns” of the working model.

In some embodiments, there is a device, having an artificial intelligence and a monitor for monitoring a working model of the artificial intelligence, wherein the artificial intelligence is configured to perform a classification of input data by means of the working model, and wherein a monitor model of the monitor is trained with a representative volume of data of the working model.

The device can, for example, be a computer. The monitor has an artificial first neural network and the input for the first neural network is formed by the representative volume of data. The artificial intelligence has an artificial second neural network, wherein the representative volume of data is formed by the output of the activation functions of the neurons of the second neural network.

In some embodiments, the device can be configured to train the monitor model by inputting the training data into the working model which is fully trained with training data once more for analysis, wherein the monitor model learns a set of valid activation patterns and/or activation paths which the working model can achieve.

In some embodiments, there is a computer program product, comprising a computer program, wherein the computer program is loadable into a storage device of a device, wherein the steps of one or more methods incorporating the teachings of the present disclosure are carried out with the computer program when the computer program is executed on the device.

In some embodiments, there is a computer-readable medium on which a computer program is stored, wherein the computer program is loadable into a storage device of a device, wherein the steps of one or more methods incorporating the teachings of the present disclosure are carried out with the computer program when the computer program is executed on the device.

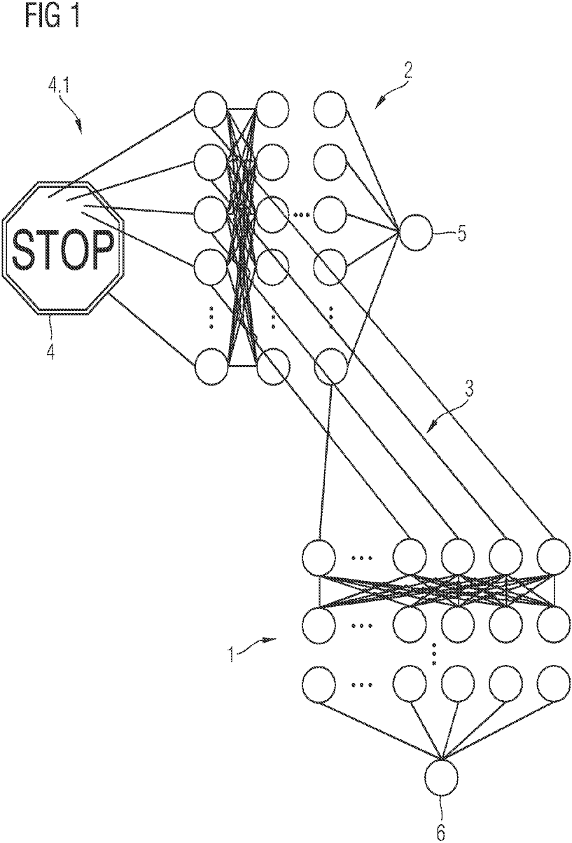

FIG. 1 shows the block diagram of an exemplary embodiment with neural networks and image recognition. A second neural network 2 is trained by means of, for example, 1000 images of stop traffic signs 4. A set of pixels 4.1 is typically assumed as an input vector. A probability as a number between 1 and 0 is generated as the output 5 of the second neural network 2, indicating the assumed level of the probability of a specific image (set of pixels 4.1) representing a stop traffic sign 4.

The training set of 1000 images is then used to train the second neural network 2, i.e. its working model. Once the working model is fully trained, the monitor model of the first neural network 1, i.e. the monitor, is trained. The 1000 images 4.1 or a representative part thereof are again analyzed by the working model, and the monitor model learns the activation patterns of the second neural network 2 (= output of the activation functions of the neurons of the second neural network 2).

After the working model and the monitor model have been trained, the system having the first neural network 1 and the second neural network 2 can be used to recognize stop signs 4. If an image containing no stop sign 4 is then incorrectly recognized by the working model as a stop sign 4, the probability of this incorrect classification being recognized by the monitor model of the first neural network 1 is high if the classification is rated as atypical on the basis of an activation pattern 3 previously learnt by the monitor model and therefore represents a deviation of the working model from its requirements. The error message is emitted by the output 6 of the first neural network 1. The monitor model can therefore also be graphically described as the “super-ego” or “conscience” of the working model.

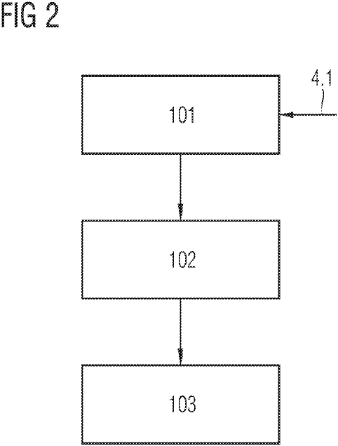

FIG. 2 shows a flow diagram of an automated method for generating a monitor model of a monitor for monitoring a working model of an artificial intelligence, based on the example of a first neural network 1 as the monitor and a second neural network 2 as the artificial intelligence.

In a first step 101, the second neural network 2 is trained with training data as input data, for example image data 4.1 of an object. In a second step 102, a representative volume of data of the training data is selected. In a third step 103, the representative volume of data is run through the second neural network 2 and its working model once more, and the monitor model of the first neural network 1 is trained with the output of the activation functions (= activation patterns and/or activation paths) of the neurons of the second neural network 2. This enables the monitor model to monitor the working model and detect errors during the operation of the working model.

Although the teachings herein have been illustrated and described in detail by means of the exemplary embodiments, the scope of the disclosure is not limited by the disclosed examples and other variations can be derived by a person skilled in the art without departing the protective scope thereof.

Reference number list

| | |
|---|---|
| 1 | First neural network (monitor) |
| 2 | Second neural network |
| 3 | Output of the activation functions of the neurons of the second neural network 2 |
| 4 | Stop sign |
| 4.1 | Set of pixels |
| 5 | Output of the second neural network |
| 6 | Output of the first neural network |
| 101 | First step: training the working model |
| 102 | Second step: selecting the representative volume of data |
| 103 | Third step: training the monitor model |

What is claimed is:

1. An automated method for generating a monitor model of a monitor having a first neural network for monitoring a working model of an artificial intelligence having a second neural network, the method comprising:
classifying input data using the working model; and
training the monitoring model using a representative volume of data of the working model;
wherein the representative volume of data is used as the input for the first neural network; and
wherein the representative volume of data is formed by the output of the activation functions of the neurons of the second neural network.

2. The method as claimed in claim 1, wherein training the monitor model includes:
putting the training data into the working model which is fully trained with training data; and
running said training data through the working model once more for analysis;
wherein the monitor model learns a set of valid activation patterns and/or activation paths which the working model can achieve.

3. A device comprising:
an artificial intelligence; and
a monitor for monitoring a working model of the artificial intelligence;
wherein the artificial intelligence is configured to perform a classification of input data using the working model,
wherein a monitor model of the monitor is trained with a representative volume of data of the working model,
wherein the monitor has an artificial first neural network;
the input for the first neural network is formed by the representative volume of data;
the artificial intelligence has an artificial second neural network; and
the representative volume of data is formed by the output of the activation functions of the neurons of the second neural network.

4. The device as claimed in claim 3, wherein:
the monitor model is trained by putting at least some of the training data into the working model which is fully trained with training data and running said training data through the working model once more for analysis; and
the monitor model learns a set of valid activation patterns and/or activation paths which the working model can achieve.

5. (canceled)

6. A non-transitory computer-readable medium storing a computer program wherein the computer program is loadable into a storage device to perform an automated method for generating a monitor of a monitor a first neural network for monitoring working of an artificial intelligence having a second neural comprising: a second neural network, the method comprising:
classifying input data using the working model; and training the monitoring model using a representative volume of data the working model;
wherein the representtive volume of data is used as the input for the first neural network;
Wherein the representative volume of data is formed by the output of the activation functions of the neurons of the second neural network.
